(19) United States
(12) Patent Application Publication
(10) Pub. No.: US 2026/0315960 A1
(43) Pub. Date: Oct. 15, 2026

(54) Filter

(71) Applicant: HYDAC Filtertechnik GmbH, Sulzbach / Saar (DE)

(72) Inventors: Alexander Nenno, Marpingen (DE); Andre Michael Schneider, Saarbrücken (DE); Klaus Morgens, Trier (DE); Marco Tassone, Saarbrücken-Eschberg (DE)

(73) Assignee: HYDAC Filtertechnik GmbH, Sulzbach / Saar (DE)

(21) Appl. No.: 19/106,469

(22) PCT Filed: Oct. 20, 2023
(86) PCT No.: PCT/EP2023/079259

§ 371 Date: Feb. 25, 2025

(30) Foreign Application Priority Data
Nov. 9, 2022 (DE) 10 2022 004 171.5

(51) Int. Cl. B01D 19/00; B01D 29/21; B01D 29/23; B01D 29/58; B01D 36/00; B01D 39/10; B01D 39/16; B01D 39/20; C25B 15/08

(52) U.S. Cl. CPC B01D 19/0031; B01D 29/21; B01D 29/232; B01D 29/58; B01D 36/001; B01D 39/10; B01D 39/1623; B01D 39/2044; B01D 39/2086; C25B 15/08; B01D 2201/0415; B01D 2239/0622; B01D 2239/1216; B01D 2239/1233

(57) ABSTRACT

The disclosure relates to a filter for treating process fluid, such as that arises during hydrogen electrolysis, having a first filter element and a second filter element, which encloses the first filter element with the formation of a flow space with a predefinable radial spacing, wherein each filter element has a filter medium through which the process fluid can flow in a flow-through direction. Seen in the flow-through direction, the one filter medium forms a first degassing stage, which is used to enlarge gas bubbles through coalescence and to remove same from the process fluid through separation caused by buoyancy, and the subsequent further filter medium forms a second degassing stage, which is used to remove very finely distributed gas bubbles remaining in the process fluid, again through coalescence and the Separation of same through rising caused by buoyancy.

### CROSS-REFERENCE TO RELATED APPLICATIONS

This application claims priority to German Patent Application DE 10 2022 004 171.5, filed on Nov. 9, 2022 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a filter for treating process fluid, such as arises in particular during hydrogen electrolysis, for example for separating hydrogen and/or oxygen from process water. DE 10 2021 001 631 A1 discloses a method for treating process fluids, such as those which arise with the aid of electric current in an electrolytic cell during the decomposition of a process liquid into mutually different process gases, with at least one fluid circuit, in which at least one of the process gases is present in contained form in the process liquid, forming the process fluid, at least one fluid storage tank being present as part of the fluid circuit, in which storage container at least one filter device is accommodated, by means of which the process fluid is cleaned of any particle contamination and, at the same time, the contained process gas is separated from the process fluid while retaining the process liquid.

The filter device used here has a for example replaceable filter element through which a fluid can flow from the inside to the outside, the filter element being surrounded by a housing wall, which is configured as an outflow pipe having a plurality of passage points, some of which are arranged below the respective variable fluid level in the fluid storage tank and the others above this fluid level, in each case maintaining a predefinable radial spacing and forming a fluid flow chamber.

### SUMMARY

A need exists to provide a further improved solution, in particular to achieve an even higher rate of separated gas from a process fluid.

The need is addressed by the subject matter of the independent claim(s). Embodiments of the invention are described in the dependent claims, the following description, and the drawings.

### BRIEF DESCRIPTION OF THE DRAWINGS

FIG. 1 shows a perspective view of an example filter;

FIGS. 2 and 3 show two different embodiments of the filter in the manner of a longitudinal section through FIG. 1;

FIGS. 4, 5 and 6, 7 show enlarged diagrams of the filter according to FIG. 2 and the filter according to FIG. 3, respectively, showing the head end and base end in each case; and

FIGS. 8 and 9 show installation situations of filters according to FIGS. 1 and 3 in an example container in a lateral view and a top view.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

The filter according to the teachings herein has a first filter element and a second filter element, which encloses the first filter element with a predefinable radial spacing, forming a flow chamber, each filter element having a filter medium through which the process fluid can flow in a flow-through direction for example from the outside to the inside or for example from the inside to the outside. The one filter medium, viewed in the flow-through direction, forming a first degassing stage, which is used to enlarge gas bubbles through coalescence and to remove same from the process fluid through separation caused by buoyancy, and the subsequent, further filter medium forming a second degassing stage, which is used to remove very finely distributed gas bubbles remaining in the process fluid, through coalescence and the separation of same again through rising caused by buoyancy.

In this way, a two-stage degassing filter is created which is combined in a single assembly and greatly improves the separation of fluid and gas compared to the known solution. In the field of hydrogen electrolysis already referred to above, oxygen and hydrogen are released from the process water as the process fluid during the course of the process. For both hydrogen and oxygen, there are two separate, process-related fluid circuits, i.e., there is a circuit with water and free hydrogen bubbles and a further circuit with water and free oxygen bubbles. A dedicated separator, the task of which is to separate the corresponding gas from the liquid, is used for each of these circuits. The gas contents which can arise within the process are definitely between 30 and 95 percent by volume and, with the degassing filter according to the teachings herein with its improved degassing rates, a significant reduction in the respective separator size or separator volume can be achieved and, thanks to the installation volume saved in this manner, the filter can be increasingly used for a plurality of practical applications. For example, the filter media of the first and second element used in each case are mutually different depending on the degassing object to be achieved.

In some embodiments of the filter, the one filter medium preceding in the flow-through direction consists of a depth filter cartridge which is designed as a hollow cylindrical filter casing to increase the filter volume. This results in a coaxial arrangement of two filter stages, which are used for degassing a process fluid, the first filter stage leading to a first coalescence of the gas bubbles, which then rise upwards in a correspondingly increased volume due to buoyancy and separate from the process fluid in this manner. The air bubbles that have not yet been separated are then retained by the second degassing stage and are again fed to a coalescence process, so that the gas bubbles, which in this respect are also finely dispersed in the fluid, increase in volume, rise due to buoyancy and are then also separated from the process fluid, usually in the form of process water.

For example, it is provided that the filter uses meltblown fibers to form the depth filter cartridge, which fibers are for example sprayed onto a fluid-permeable supporting body on which the filter casing is supported along its inner circumferential side. The depth filter cartridge used is designed to be extremely voluminous compared to a pleated element material, which brings with it an improved gas discharge behavior. In this respect, the meltblown depth filter cartridge forms a hollow cylindrical, solid filter casing block with predefinable porosity.

Instead of constructing the depth filter cartridge from meltblown fibers, there is also the option of constructing it from a sintered material, either in the form of a sintered metal filter or in the form of a ceramic filter each with predefinable filter permeability.

For reliable degassing processes with a high separation rate, it has proven beneficial to select the filter fineness of the depth filter cartridge between 10 μm and 200 μm. If meltblown fibers are used increasingly or exclusively for the depth filter cartridge, the fiber diameter is for example between 0.1 μm and 2000 μm and the mean flow pore size (MFP) is between 1 μm and 2000 μm.

For a homogeneous structure of the filter, all substantial components thereof are for example made of one and the same plastic material and if metals such as stainless steel or titanium are used as filter medium for the filter, it is for example provided that in any case all filter media consist of one and the same metal material.

For example, it can be provided that the filter medium following the one filter medium in the flow-through direction has at least a two-layer, for example three-layer mat structure, which allows additional improved particle removal from the fluid flow.

The disclosure further relates to a device having a container for accommodating at least one filter as described above, the container having at least one inlet for gas-containing process fluid and an outlet for the gas separated in the container and a further outlet for the process fluid freed of the gas, the flow through the respective filter, starting from the inlet of the container, being from the inside to the outside, transferring the separated gas above a fluid level in the container to the one outlet in the container and process fluid accumulated in the container below this fluid level being discharged from the container via the further outlet. It is for example provided in this case that a parallel incident flow of the respective filter in the container takes place from below via openings in a separating plate in the container, which extends parallel to the fluid level that is adjusted during operation and that a suction connection is provided between the individual filters, which opens out above the adapter plate and below the fluid level in the container and is connected to the further outlet for the process fluid.

Reference will now be made to the drawings in which the various elements of embodiments will be given numerical designations and in which further embodiments will be discussed.

Specific references to components, process steps, and other elements are not intended to be limiting. Further, it is understood that like parts bear the same or similar reference numerals when referring to alternate FIGS. The FIGS. are schematic and not necessary to scale.

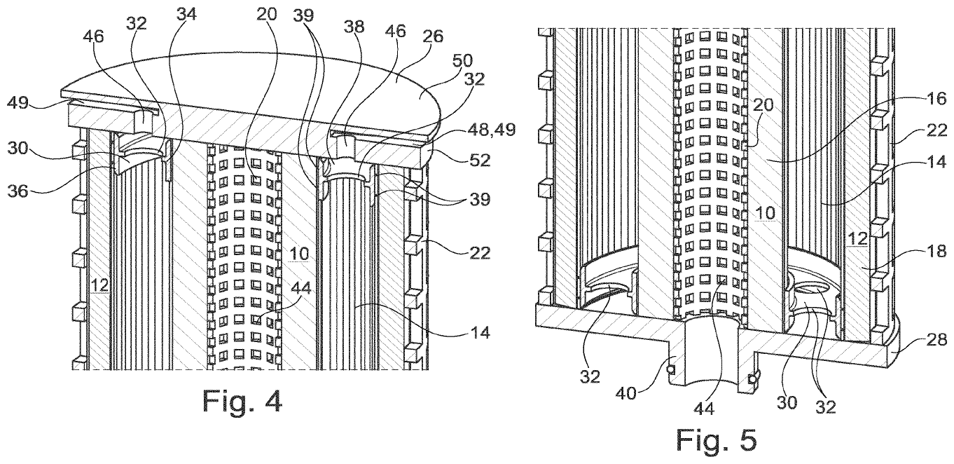

FIG. 2 as well as 4 and 5 relate to a first embodiment of the filter according to the teachings herein. The aforementioned filter is used for treating process fluid, such as arises in particular during hydrogen electrolysis, for example for separating hydrogen and/or oxygen from process water. Combined in a single assembly, the filter has a first filter element 10 and a second filter element 12, which encloses the first filter element 10 with the formation of a flow chamber 14 with a predefinable radial spacing.

It is further provided that the first filter element 10 has a first filter medium 16 and the second filter element 12 has a second filter medium 18. The first filter medium 16 is supported on the inner circumferential side on a fluid-permeable supporting body 20 in the form of a support grid. The second filter medium 18 is enclosed on the outer circumferential side by a further fluid-permeable supporting body 22, which is also configured in the manner of a support grid. Further fluid-permeable supporting bodies, not shown, can also be arranged on the outer circumferential side of the first filter medium 16 if necessary and on the inner circumferential side of the second filter medium 18. In the present case, flow through the filter takes place in the flow-through direction from the inside to the outside, the aforementioned flow-through direction being represented in the FIG. 2 by an arrow 24.

The first filter medium 16 is accommodated together with its inner supporting body 20 between an upper end cap 26 and a lower end cap 28. The second filter medium 18 with the further supporting body 22 is accommodated between the same end caps 26, 28 and with a correspondingly identical axial overall length. In this respect, the respective end-face ends of the first and second filter medium 16, 18 and the two supporting bodies 20, 22 are connected firmly or fluid-tight to the end caps 26, 28, for example using a mirror welding procedure. Further details of the end caps 26, 28 will be described in even greater detail below. Again viewed in the flow-through direction 24, the one first filter medium 16 forms a first degassing stage, which is used to enlarge gas bubbles through coalescence and to remove same from the process fluid through separation caused by buoyancy. The subsequent, further filter medium 18 forms a second degassing stage, which is used to remove very finely distributed gas bubbles remaining in the process fluid, again through coalescence and the separation of same through rising caused by buoyancy. The first degassing stage formed in this respect by the first filter element 10 as a whole is thus used to enlarge existing gas bubbles, which then rise in the process fluid and are separated on the surface of the process fluid in this manner. The second filter element 12, which in this respect forms the second degassing stage, is used in this respect for subsequently separating the very finely distributed gas bubbles remaining in the process fluid by coalescing them into larger bubbles and separating them through rising caused by buoyancy.

In some embodiments of the filter, the inner filter stage in the form of the filter element 10 consists of a voluminous meltblown depth filter cartridge made of polypropylene. The filter fineness of the depth filter cartridge is for example between 10 μm and 200 μm; alternatively, a sintered filter with the same filter fineness, which is not shown in greater detail here, can be used. For example, for producing a depth filter cartridge from meltblown fibers, they are sprayed onto the inner supporting body 20. The outer filter stage with the second filter medium 18 consists of a three-layer, pleated structure made of polypropylene fabric. For example, in this case, the mesh size of the two outer layers, which are directed towards the supporting body 22, is approximately 200 to 1000 μm, which is relatively coarse. In contrast, the mesh size of the inner layer is 0.1 to 500 μm, which can be referred to as relatively fine. The pleat density of the pleated filter mat, which in this respect forms the second filter medium 18, is 0.1 to 6 pleats per centimeter.

In addition to the aforementioned polypropylene material, polyamide or polyester can be used as further plastic materials for production. If one and the same plastic material is used for the filter media 16, 18 and for the supporting bodies 20 and 22 and for the end caps 26, 28, a homogeneous structure is achieved which helps to make recycling the filter as a whole easier. Twill or satin weaves can be used as weave types for the second filter medium 18, as can so-called plain fabrics. The use of further weave types is possible here. In addition to the three-layer structure described, there is also the option of a structure with two to five layers, the mesh size, viewed in flow-through direction 24, for example being from coarse to fine.

For the mirror welding procedure already referred to, two identically configured centering rings 30, which are provided with through holes 32, are inserted into the flow chamber 14 in the region of the upper end cap 26 and also in the region of the lower end cap 28. The upper centering ring 30, viewed in the direction of FIG. 2, is fixed in turn to the upper end cap 26 with its upper free end face by means of mirror welding and the through holes 32 incorporated in the centering ring 30 are used for rising gas bubbles to pass out of the flow chamber 14 between the two filter media 16, 18. Similarly, the lower centering ring 30, viewed in the direction of FIG. 2, is mirror-welded to the lower end cap 28 with its lower free end face. For this purpose, the respective centering ring 30 has an annular locating bar 34 on the inner circumference and, similarly, an annular locating bar 36 on the outer circumference. Approximately centrally between the aforementioned bars 34, 36 accommodate a base portion 38 of the respective centering ring 30, in which base portion the through holes 32 are incorporated. The through holes 32 extend at discrete distances from each other along the base portion 38 which is parallel to the orientation of the end caps 26, 28. Towards the outside, the respective locating bar 34, 36 is supported on upper parts of the outer circumference of the first filter medium 16 and on the inner circumference of the second filter medium 18. For the sake of simplicity, the two centering rings 30 are configured identically, the lower centering ring 30, viewed in the direction of FIG. 2, not necessarily needing to have the through holes 32 for the removal of gas bubbles. In any case, the upper and lower free end faces of the two locating bars 34, 36 of each centering ring 30 are also mirror-welded to the associated end cap 26 and 28, respectively. Instead of the mirror welding referred to, other welding procedures can be used, for example the laser transmission welding procedure, as shown by way of example in documents DE 10 2007 013 178 A1 and DE 10 2010 005 541 A1 of the proprietor. Ultrasonic welding procedures can also be used; the production of adhesive joints is also conceivable. The two bars 34, 36 each have pairs of protruding centering bars 39 towards the outside in the direction of the filter media 16, 18, which centering bars can at least partially penetrate into the flexibly yielding filter media 16, 18, so as in this respect to facilitate or enable positioning of the bars 34 for the welding operation within the filter. The centering bars 39 are an annular integral part of the respective locating bar 34, 36.

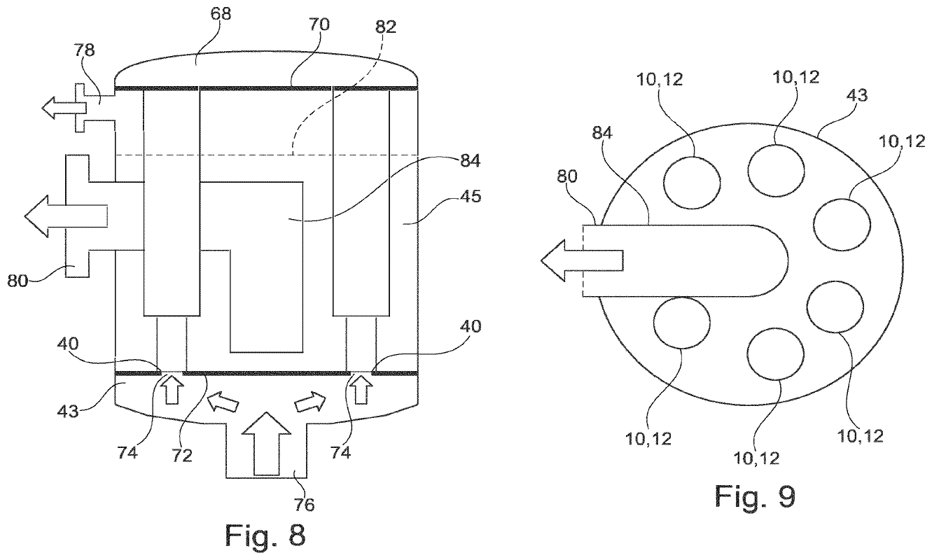

The lower end cap 28 has a downwardly protruding, hollow cylindrical annular connector 40 with a sealing device 42 in the form of an O-ring which is accommodated in an outer circumferential groove of the annular connector 40. In this way, the filter as a whole can be fixed in a container housing 43, sealed with respect to the environment, as shown in FIGS. 8 and 9, and the gas-containing process fluid can be supplied via the hollow through-channel of the annular connector 40 to the central inner side 44 of the filter which, designed as an inflow chamber, is enclosed most closely by the supporting body 20 together with the first filter medium 16. However, the sealing device 42 with O-ring can also be omitted to maintain a homogeneous structure and can be replaced by a clamped joint which is not shown. From this inner side 44, the process fluid travels along the flow-through direction 24 into the flow chamber 14 after passing through the first filter element 10 and, viewed from there, via the second filter element 12 with the subsequent further supporting body 22 to the outer side 45 of the filter, which corresponds to the interior of the container housing 43 as part of a container mounting for the respective filter and will be explained in even greater detail with reference to FIGS. 8 and 9.

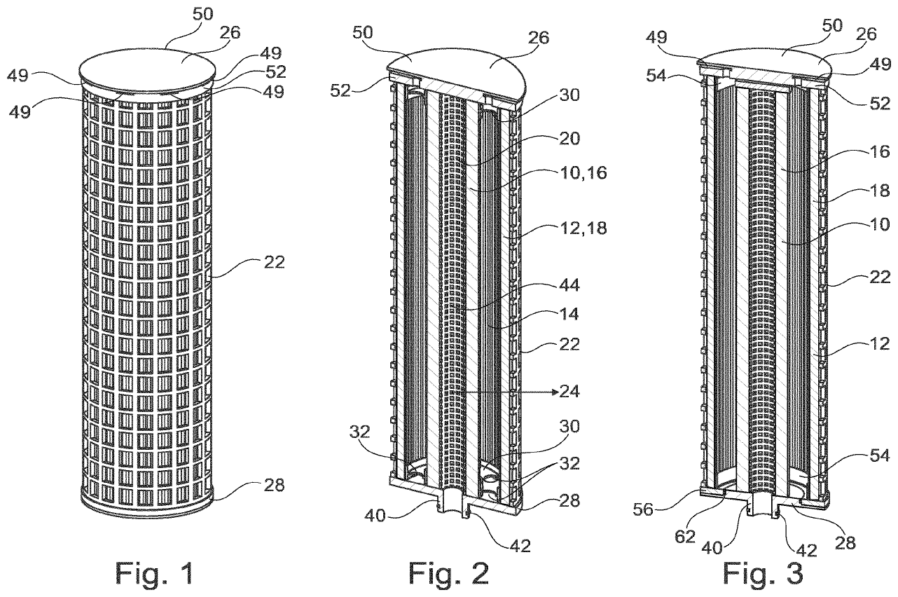

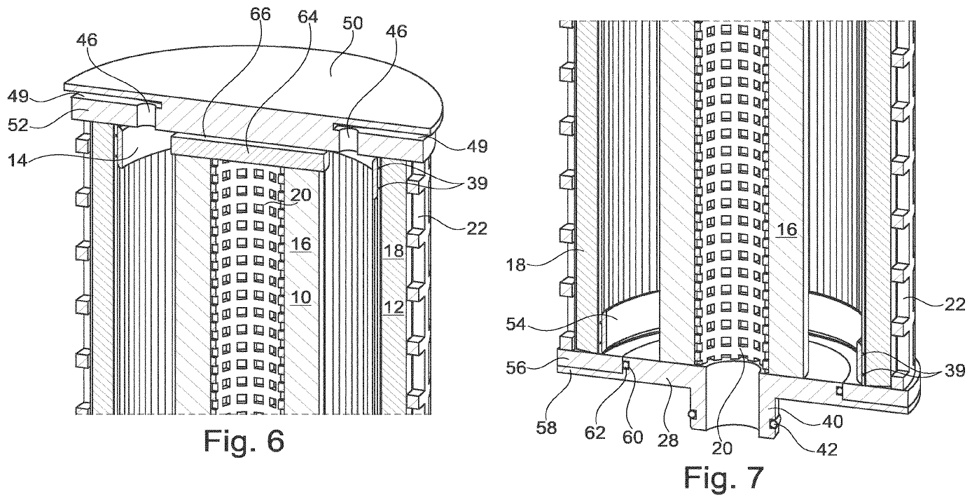

The upper end cap 26 has outlet openings 46 coaxial with the orientation of the upper through holes 32 in the centering ring 30, which, as shown in particular in FIG. 4, open out with their one free end into the flow chamber 14 above the centering ring 30 and with their other free end into an annular gap 48 which, starting from the inner side of the upper end cap, which in this respect is closed, opens out on the outer side 45 of the filter. To form the circumferential annular gap 48 (not shown), an upper cap region 50 is separated from a lower end cap region 52 of the upper end cap 26, forming a radially outwardly protruding shoulder. Instead of a common annular gap 48 for all outlet openings 46 in the cover region of the end cap 26, each outlet opening 46 is, for example connected, as shown, to the outer side 45 of the filter via its own flow channel 49, as shown in particular in FIG. 1. Furthermore, it has proven to be favorable to make the respective flow channel 49 relatively narrow and the free diameter of the outlet openings 46 is chosen to be smaller than the free diameter of the through holes 32 in the centering ring 30. In any case, gas bubbles rising in the flow chamber 14 reach the individual flow channels 49 of the upper end cap 26 in this way via the through holes 32 in the upper centering ring 30 and via the outlet openings 46, so that in this way they can be discharged from the process fluid and from the filter to the environment in the form of the filter outer side 45.

In the coaxial arrangement of two filter stages with a flow from the inside to the outside and with an incident flow from below via the annular connector 40, the filter media 16, 18 can also be constructed homogeneously of metal materials, in particular stainless steel or titanium, instead of the previous media structure.

In the aforementioned embodiment, the inner filter stage in the form of the first filter medium 16 is a three-layered, pleated structure made of stainless steel. This structure replaces the voluminous meltblown structure from the polypropylene version shown above. The mesh size of the two outer layers, viewed in the direction of the flow chamber 14, is in turn relatively coarse with values between 200 and 1000 μm. In contrast, the mesh size of the subsequent inner layer is relatively fine and has values between 0.1 and 500 μm. Titanium can also be readily used in addition to the stainless-steel material. The pleat density of the pleated filter material is 4 to 8 pleats per square centimeter and the types of weave used, for example, can be twill, satin, plain weave, etc. A structure with 2 to 5 layers is also conceivable; here too, the mesh size should go from coarse to fine in the flow-through direction 24. Alternatively, sintered filters with similar degassing properties can also be used.

The outer filter stage in the form of the second filter medium 18 also consists of a three-layer, pleated structure made of stainless steel with comparable mesh sizes outside and inside, as indicated above. For example, the pleat density is 0.1 to 6 pleats per centimeter and the types of weave described above are also used. Coating of the overall filter or only the individual woven fabrics 16, 18 can lead to a further improvement in the degassing properties, particularly if the coating is applied with coalescence-promoting materials. The materials used for the filter media 16, 18 can also be passivated in this way to prevent the release of electrons and iron ions. As far as the operating principle of a two-stage degassing filter, which has a homogeneous metallic structure, is concerned, this corresponds to the solution presented above. Instead of the welding procedures presented, the metallic filter media 16, 18 can also be bonded to the respectively associated end caps 26, 28 or crimped together as part of a metallic joining technique (not shown). For an improved degassing process, it has proven beneficial to select the pleat density for the first filter medium 16 correspondingly high and for the outer filter medium 18 correspondingly low.

The second embodiment according to FIG. 3 as well as 6 and 7 is only explained below to the extent that it differs significantly from the embodiment described above. In particular, the same reference numerals as specified above are used for the same components and the explanations given in this regard also apply accordingly for the further second embodiment. Instead of the centering ring 30 described above, a simple circumferential positioning ring 54 is used for the second embodiment, which ring is supported with a predefinable axial extension on the inner circumferential side of the second filter medium 18 in each case and also in each case towards its free end regions. The respective positioning ring 54 in turn has pairs of centering bars 39 on the outer circumferential side which engage at least partially in the second filter medium 18 on the inner circumferential side thereof to ensure in this way that the positioning ring 54 is fixed in position on the respective end region of the second filter medium 18. In this way, the mirror welding procedure can be effectively supported by the two positioning rings 54.

FIG. 7 shows in particular, the second filter element 12 with its outer supporting body 22 as well as the second filter medium 18 and the lower positioning ring 54 is connected, in particular welded, to an independent annular cap 56 which, in the installation position shown in FIG. 7, is supported at the base end on a flange-like protrusion 58 of the lower end cap 28. In this way, the annular cap 56 rests on parts of the lower end cap 28 without extending beyond them. For sealing, in the region of the step-like transition between the protrusion 58 and the other lower end cap 28, a further sealing device 62 is inserted in a radially outwardly open annular groove 60 thereof, which sealing device seals the interior of the filter with respect to the environment in the form of the filter outer side 45. Just like the first sealing device 42 on the annular connector 40, the further sealing device 62 can also be dispensed with if a clamped joint, not shown, is to be used at the respective joining point, which can be additionally secured by means of a welded or adhesive bond.

Accordingly, the outer supporting body 22 and the second filter medium 18 together with the lower positioning ring 54 is welded, in particular mirror-welded, to the upper side of the annular cap 56 on the base end. Furthermore, on its underside the inner supporting tube 20 together with the underside of the associated filter medium 16 is welded, in particular mirror-welded, to the upper side of the actual lower end cap 28. Correspondingly, the upper end of the outer supporting body 22 with the associated second filter medium 18 and the upper positioning ring 54 is welded to the lower, flat end face of the upper end cap 26. In the aforementioned embodiment, the outlet openings 46 in the upper end cap 26 also open into the flow chamber 14.

What differs from the embodiments described above, however, is that the first filter element 10 has its own end cap 64 which, configured as a flat annular disc, leaves open a gap-shaped passage space 66 which is formed from the upper side of the end cap 64 and the adjacent underside of the upper end cap 26. In this way, the hollow cylindrical flow chamber 14 is connected in a media-conducting manner at its upper end via the passage space 66. This also enables tolerance compensation between the two filter elements 16 18. The same materials as described above are again used for the entire structure of the filter according to the second embodiment. The connections joining the individual filter components together to obtain an overall filter can be implemented particularly cost effectively using the materials referred to together with the mirror welding procedure mentioned and, with regard to the strong welded joints, the filter can be designed overall as an easily recyclable, disposable product. If the filters according to FIGS. 2 and 3 are viewed from outside, the result is the illustration of FIG. 1.

FIGS. 8 and 9 show, a total of six filters as described above are inserted into a container housing 43, with a cover part 68 that can be removed from the housing 43 for the purpose of removing spent filters and replacing them with new elements. The cover part 68 is provided with a holding-down device 70 to keep the individual filters consisting of a first and second filter element 10, 12 in position. For this purpose, when the cover part 68 is closed, the holding-down device 70 presses the individual filters down via the respective annular connector 40 onto a separating or adapter plate 72 with correspondingly designed annular recesses 74. In addition, the container housing 43 or the container has an inlet 76 on the base end for gas-containing process fluid as well as an outlet 78 for the gas separated in the container 43 and a further outlet 80 for the process fluid freed of the gas, the flow through the respective filter, starting from the inlet 76 of the container 43, being from the inside to the outside. The separated gas is transferred to the one outlet 78 in the container 43 above a fluid level 82 in the container 43. In contrast, process fluid which has accumulated below this fluid level 82 in the container 43, leaves the container 43 via the further outlet 80.

For a parallel incident flow of the respective filter from below via the openings, in the form of annular recesses 74, in the adapter or separating plate 72 in the container 43, orientated vertically according to the diagram of FIG. 8. In particular, the respective filter is guided out upwardly above the fluid level 82 and extends between the separating or adapter plate 72 and the holding-down device 70. For improved discharge of the process fluid or process water, a suction connection 84 is provided between the individual filters, which suction connection opens out laterally above the separating or adapter plate 72 and below the fluid level 82 in the container 43 and in this respect is connected to the further outlet 80 for the process fluid. In this way, it is readily possible to accommodate 3 to 30 degassing filters in one tank in the form of the container 43. The number of filters used can be selected depending on the volume flow rate to be treated. The parallel incident flow of the degassing filters from below via the separating or adapter plate 72 is significant. The container 43 or the container housing is for example made of stainless steel and has an internal coating for passivation and corrosion protection. The gas bubbles separated by the first filter medium 16 and the second filter medium 18 through coalescence and separation caused by buoyancy pass via the flow chamber 14 from the process fluid side to the gas side, which is above the fluid level 82 in the container 43. As already explained, the gas accumulated in the flow chamber 14 then reaches the gas discharge side of the container 43 with the gas connection 78 via the channel guides in the upper end cap 26, which are arranged above the fluid level 82. Overall, gas-containing process fluid flows through the two filter stages in the form of the first filter element 10 and second filter element 12 with the associated filter media 16, 18 one after the other. The first filter stage in the form of the first filter element 10 then leads to a first coalescence or a pre-separation of the gas bubbles (air/hydrogen/oxygen). The retained gas bubbles coalesce and rise upwards, as do the enlarged gas bubbles after flowing through the filter stages 10, 12 in the annular gap between the first 10 and the second stage 12 formed by the flow chamber 14. After passing through the degassing openings indicated in the upper end cap 26, the gas bubbles pass over the fluid surface, i.e. over the fluid level region 82 shown in FIG. 8 which varies in height. The air bubbles that have not yet been separated are retained by the outer second degassing stage in the form of the second filter element 12, coalesce in this respect and then also rise upwards due to buoyancy, above the fluid level 82. Using corresponding container geometries, the filter arrangements referred to can be used for any degassing operations for process fluids and are not restricted to process waters, such as arise during hydrogen electrolysis.

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the function of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

What is claimed is:

1-10. (canceled)

11. A filter for treating process fluid such as arises during hydrogen electrolysis, having a first filter element and a second filter element, which encloses the first filter element with the formation of a flow chamber with a predefinable radial spacing, wherein each filter element has a filter medium through which the process fluid can flow in a flow-through direction from the outside to the inside or from the inside to the outside, wherein, viewed in the flow-through direction, the one filter medium forms a first degassing stage, which is used to enlarge gas bubbles through coalescence and to remove same from the process fluid through separation caused by buoyancy, and the subsequent, further filter medium forms a second degassing stage, which is used to remove very finely distributed gas bubbles remaining in the process fluid, again through coalescence and the separation of same through rising caused by buoyancy.

12. The filter of claim 11, wherein the one filter medium preceding in the flow-through direction comprises a depth filter cartridge which is configured as a hollow cylindrical filter casing to increase the filter volume.

13. The filter of claim 12, wherein meltblown fibers are used to form the depth filter cartridge.

14. The filter of claim 13, wherein the depth filter cartridge is made of a sintered material.

15. The filter of claim 12, wherein the filter fineness of the depth filter cartridge made of meltblown fibers is between 10 μm and 200 μm, the fiber diameter is between 0.1 μm and 2000 μm, and the mean flow pore size is between 1 μm and 2000 μm.

16. The filter of claim 11, wherein, for a homogeneous structure, all components of the filter, such as filter media, end caps and supporting bodies consist of one and the same plastic material.

17. The filter of claim 11, wherein the filter medium following the one filter medium in the flow-through direction has at least a two-layer mat structure.

18. The filter of claim 11, wherein, for a homogeneous structure, the respective filter medium is constructed of metals, such as stainless steel or titanium, forming a two-stage degassing filter and wherein the respective filter medium of at least one filter element has at least a two-layer pleated mat structure of metal threads or metal fibers.

19. A device having a container for accommodating at least one filter according to claim 11, which has at least one inlet for gas-containing process fluid and an outlet for the gas separated in the container and a further outlet for the process fluid freed of the gas, wherein the flow through the respective filter, starting from the inlet of the container, is from the inside to the outside, transfers the separated gas above a fluid level in the container to the one outlet in the container and process fluid accumulated in the container below this fluid level is discharged from the container via the further outlet.

20. The device of claim 19, wherein a parallel incident flow of the respective filter takes place from below via openings in a separating plate in the container, which extends parallel to the fluid level and in that a suction connection is provided between the individual filters, which opens out above the separating plate and below the fluid level in the container and is connected to the further outlet for the process fluid.

21. The filter of claim 11, configured for separating hydrogen and/or oxygen from process water.

22. The filter of claim 13, wherein the fibers are sprayed onto a fluid-permeable supporting body, on which the filter casing is supported along its inner circumferential side.

23. The filter of claim 11, wherein, for a homogeneous structure, all components of the filter, such as filter media, end caps and supporting bodies consist of polypropylene.

24. The filter of claim 11, wherein the filter medium following the one filter medium in the flow-through direction has at least a three-layer mat structure.

25. The filter of claim 18, wherein the respective filter medium of at least one filter element has at least a two-layer pleated mat structure of metal threads or metal fibers and is constructed entirely from stainless steel materials.

26. The device of claim 19, wherein the one filter medium preceding in the flow-through direction comprises a depth filter cartridge which is configured as a hollow cylindrical filter casing to increase the filter volume.

27. The device of claim 19, wherein meltblown fibers are used to form the depth filter cartridge.

28. The device of claim 19, wherein the depth filter cartridge is made of a sintered material.

29. The device of claim 19, wherein the filter fineness of the depth filter cartridge made of meltblown fibers is between 10 μm and 200 μm, the fiber diameter is between 0.1 μm and 2000 μm, and the mean flow pore size is between 1 μm and 2000 μm.

30. The device of claim 19, wherein, for a homogeneous structure, all components of the filter, such as filter media, end caps and supporting bodies consist of one and the same plastic material.
